(19) United States
(12) Patent Application Publication
(10) Pub. No.: US 2005/0223065 A1
(43) Pub. Date: Oct. 6, 2005

(54) Corporate electronic mail framing

(75) Inventors: Arik Simchis, Petach Tikva (IL); Eyal Mor, Rosh Haayn (IL)

Correspondence Address: DR. MARK FRIEDMAN LTD.;C/o Bill Polkinghorn, Discovery Dispatch, 9003 Florin Way, Upper Marlboro, MD, 20772, US

(73) Assignee: BLUE SYSTEMS INC

(21) Appl. No.: 10/880,451

(22) Filed: Jul. 1, 2004

Related U.S. Application Data
(60) Provisional application No. 60/558,704, filed on Apr. 2, 2004.

(51) Int. Cl. G06F 15/16

(52) U.S. Cl. 709/206

(57) ABSTRACT

A server for modifying electronic mail messages being sent from a computer network, the original electronic mail messages being sent with an electronic mail server by users of the network to recipients, the server including a database storing frame content as well recipient and user identifiers and framing rules; and a processor for superimposing a frame onto one of the original electronic mail messages based on the recipient of the original electronic mail message thereby producing a framed electronic mail message. Preferably, the database further stores user identifiers and the superimposing of frames onto the original electronic mail message is further based on the user identifiers.

### CROSS REFERENCE TO RELATED APPLICATIONS

This application claims the benefit from U.S. provisional application 60/558704 filed on 2 Apr. 2004 by the same inventors.

### FIELD AND BACKGROUND OF THE INVENTION

The present invention relates to electronic mail and, more particularly, to a system and method for dynamically adding marketing and promotional information to electronic mail messages outgoing from corporate users. A dedicated electronic mail framing server adds this information based on corporate marketing policy.

During the past decade or more, electronic mail has become a dominant means of inter-corporate and interpersonal communications. FIG. 1 illustrates a conventional electronic mail message appearing on a computer display. As is readily seen, the electronic mail message of FIG. 1 is devoid of any marketing or promotional content, other than information included as text as part of the signature of the sender. Many corporations request from their employees to add to their personal signatures a link to the corporate Internet web site.

Client applications exist, that permit individuals to add graphics; text features backgrounds etc. to electronic mail messages to “personalize” electronic mail messages. These client applications offer the individual user to add, for instance, a happy face or perhaps a soft blue background to his/her personal electronic mail messages. The use of these client applications is not appropriate for a corporate setting because each employee will personalize his/her electronic mails in an inconsistent way, generally not conveying a corporate image desired by the marketing department.

Prior art electronic mail server applications exist that tack text messages onto all outgoing electronic mail messages. For example, the text message, as follows is intended to protect the intellectual property of the corporation:
Information contained in this email message is intended only for use of the individual or entity named above. If the reader of this message is not the intended recipient, or the employee or agent responsible to deliver it to the intended recipient, you are hereby notified that any dissemination, distribution or copying of this communication is strictly prohibited. If you have received this communication in error, please immediately notify the postmaster@ABC.com and destroy the original message.
   Text messages, such as the one shown above, are not edited based on the recipient or the sender and do not reflect corporate marketing policy. Current electronic mail server applications do not support adding graphics and other customized promotional information to outgoing electronic messages for recipients in targeted populations.

There is thus a need for, and it would be highly advantageous to have, a system and method for adding information to electronic mail messages outgoing from corporate employees. A dedicated electronic mail framing server adds the information based on framing rules, defined by corporate marketing manager, representing corporate marketing policy. The content of the electronic mail framing is altered based on the sender and/or the recipient of the outgoing electronic mail message.

### SUMMARY OF THE INVENTION

According to the present invention there is provided a server for modifying electronic mail messages being sent from a computer network, the original electronic mail messages being sent with an electronic mail server by users of the network to recipients, the server including: (a) a database storing frames and recipient identifiers; and (b) a processor superimposing a frame onto an original electronic mail message based on the recipient identifier of the original electronic mail message thereby producing a framed electronic mail message. Preferably the database further stores framing rules corresponding to the recipient identifiers. Preferably, the database further stores identifiers of the users and the superimposing is further based on one of the user identifiers. Preferably, the server further includes a mail transfer agent receiving the original mail messages from the electronic mail server and sending the original electronic mail messages to the processor and sending the framed electronic mail message to the recipient. Preferably, the mail transfer agent is configured to send the framed electronic mail message to a mail relay server. Preferably, the server further includes a communications interface with an external management application.

According to the present invention there is provided a method for modifying electronic mail messages being sent from a computer network, the original electronic mail messages being sent with an electronic mail server by users of the network to recipients, the method including: (a) storing frames, recipient identifiers; and (b) superimposing a frame onto one of the original electronic mail messages based on the recipient identifier of one of the original electronic mail messages thereby producing a framed electronic mail message. Preferably, the storing further includes user identifiers and wherein the superimposing of frames is further based on the user identifiers. Preferably, the data base further stores framing rules corresponding to the identifiers. Preferably, the method includes prior to superimposing frames receiving the original mail messages from the electronic mail server and sending the framed electronic mail message to the recipient. Preferably, sending the framed messages is via a mail relay server. Preferably, the method further includes sending commands thereby controlling the storing and superimposing; and receiving reports regarding the storing and regarding the superimposing.

According to the present invention there is provided a system for modifying electronic mail messages being sent from a computer network, the original electronic mail messages being sent with an electronic mail server by users of the network to recipients, the system including: (a) an electronic mail framing server including a database storing frames, and recipient identifiers; and further including a processor superimposing a frame onto one of the original electronic mail message based on the recipient identifier of the original electronic mail message thereby producing a framed electronic mail message; and (b) at least one management console for controlling the electronic mail framing server and receiving reports from the electronic mail framing server. The system further includes a mail relay server configured to receive electronic mail messages output from the electronic mail framing server. Preferably, the database further stores user identifiers and the superimposing is further based on one of the user identifiers.

### BRIEF DESCRIPTION OF THE DRAWINGS

The invention is herein described, by way of example only, with reference to the accompanying drawings, wherein:

FIG. 1 is a prior art drawing of a conventional electronic mail message as shown on a computer display;

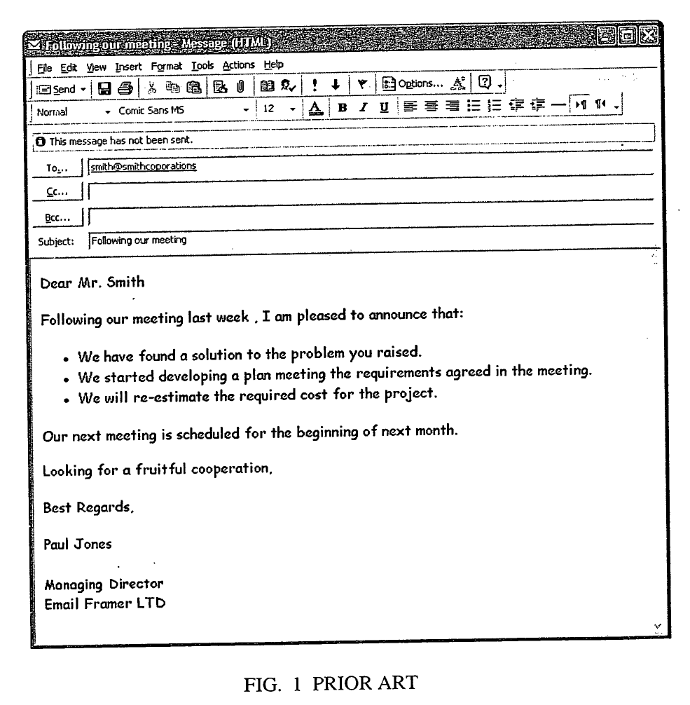

FIG. 2 is a drawing of an electronic mail message, as generated according to an embodiment of the present invention;

FIG. 3 is a drawing of a system configuration, according to an embodiment of the present invention;

FIG. 4 is a drawing of the core software modules, according to an embodiment of the present invention;

FIG. 5 is a drawing of the message flow, according to an embodiment of the present invention;

FIG. 6 is a flow diagram of the electronic mail message processing, according to an embodiment of the present invention;

FIG. 7 is a flow diagram showing management console communication, according to an embodiment of the present invention;

FIG. 8 is a simplified system drawing of an electronic mail framing system, according to an embodiment of the present invention;

FIG. 9 is a simplified system drawing of an electronic mail framing system, according to an embodiment of the present invention;

FIG. 10 is a simplified system drawing of an electronic mail framing system, according to an embodiment of the present invention.

### DESCRIPTION OF THE PREFERRED EMBODIMENTS

The present invention is a system and method for dynamically adding customized information to electronic mail messages outgoing from corporate users to recipients belonging to specific targeted populations. A dedicated electronic mail framing server adds the information based on corporate marketing policy. Furthermore, the present invention can be used to define the information added to outgoing electronic mail messages, based on specific groups targeted as recipients of outgoing electronic mail messages and based on the departments or roles of the senders of the electronic mail messages.

The principles and operation of a system and method for dynamically adding information to electronic mail messages outgoing from corporate employees, according to the present invention may be better understood with reference to the drawings and the accompanying description.

Before explaining embodiments of the invention in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

By way of introduction, principle intentions of the present invention are to: (1) provide a corporate solution that automatically “wraps” regular outgoing electronic mail messages with additional graphical and/or text information based on corporate policy and (2) provide a mechanism to dynamically manage the content and properties of the information, e.g promotional information, added to outgoing electronic mail messages based on senders and targeted recipient groups. The terms “framing” and “wrapping” are used herein interchangeably. It should be noted that while the discussion herein is directed to a corporation, the principles of the present invention may be adapted for use in, and provide benefit for, any type of organization or association.

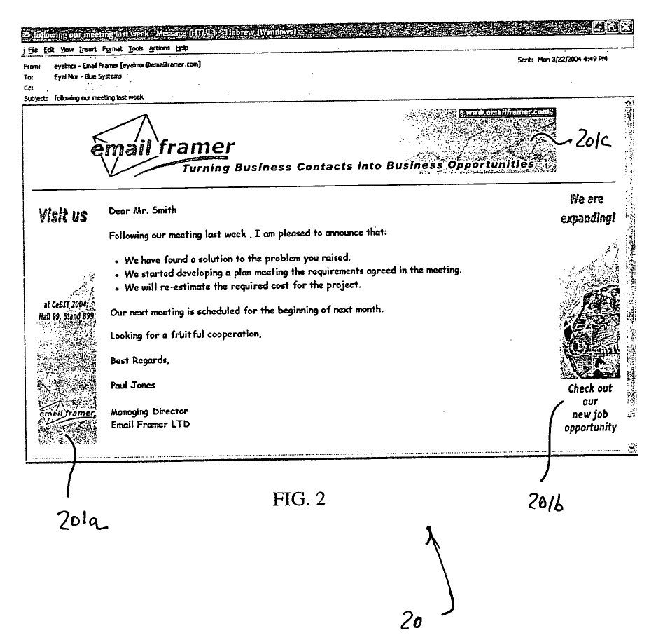

Referring now to the drawings, FIG. 2 illustrates an example of an electronic mail message 20 “framed” or “wrapped” according to an embodiment of the present invention, as shown to a recipient on a computer display screen. The electronic mail message is wrapped, for instance, with graphic entities 201, providing promotional information to the recipient. The term “frame” is defined herein to include graphic entities 201 and/or text superimposed onto conventional electronic mail messages. The terms “add” and “superimpose” are used herein interchangeably.

The sender of the electronic mail message 20, according to an embodiment of the present invention is unaware that the message recipient has received promotional information in addition to the text message drafted by the sender. Graphics entities 201, for instance, provide links to specific Internet addresses. In the example shown in FIG. 2, graphics entity 201a is a promotional item to visit a corporate booth at a professional exhibit, graphics entity 201b is a link to a job opportunities section of a corporate Internet site and graphics entity 201c provides a promotional banner as well as a link to a corporate home page. According to an embodiment of the present invention, when electronic mail recipients initiate links, ie. graphics entities 201 are “clicked”, recipient data is collected as basis for statistical and detailed reports useful for marketing and sales.

It should be noted that the style of the “wrapping” of the outgoing messages is configurable by for instance, the marketing department and the choice of style used in FIG. 2 is for illustrative purposes only and should not be regarded as limiting.

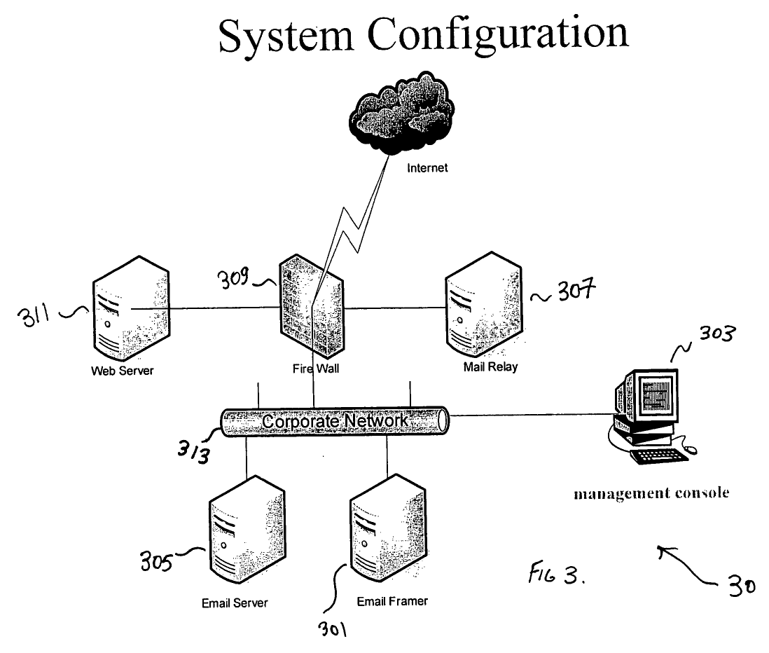

A system configuration of an electronic mail framing system 30, according to an embodiment of the present invention is shown in FIG. 3. Electronic mail framing system 30 includes, a dedicated electronic mail framing server 301 including a processor that functions to wrap outgoing electronic mails according to corporate marketing policy. Electronic mail framing system 30 further includes a management console 303 that is used to communicate with and manage an electronic mail framing application installed on electronic mail framing server 301. In the example of electronic mail framing system 30, an electronic mail server 305 and electronic mail framing server 301 are both included in a high security zone of corporate network 313. Communications with the Internet is mediated through a firewall 309 and in the “demilitarized zone” (DMZ) are an Internet server 311 and a mail relay server 307.

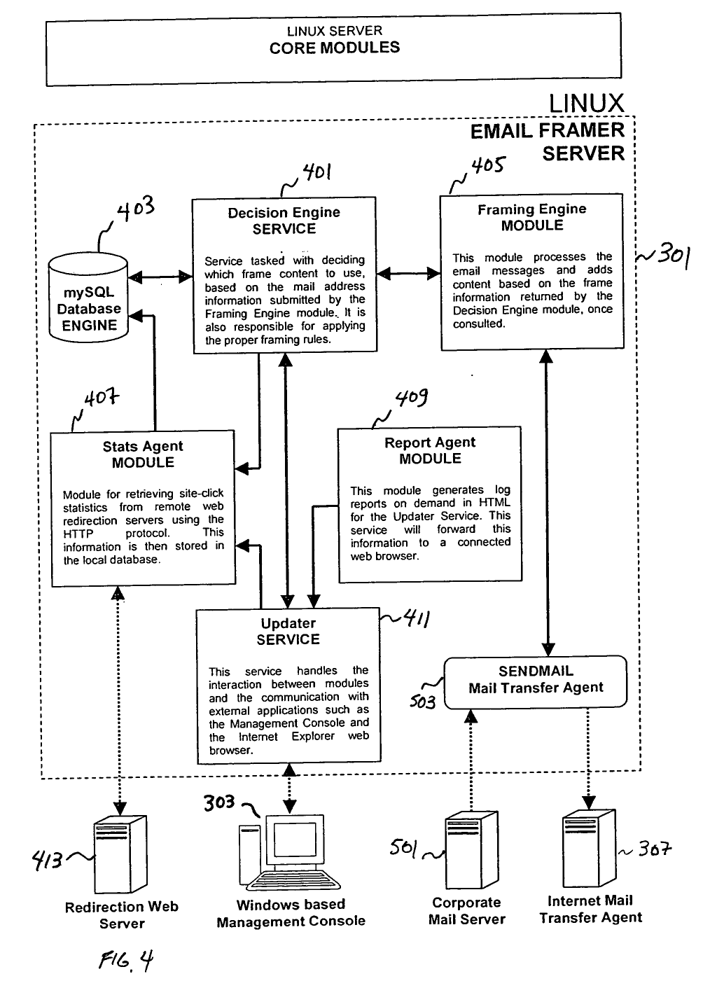

FIG. 4 is a drawing showing major software modules installed in the processor of and functional in electronic mail framing server 301. A decision engine module 401 decides which frame content to use based on framing rules. Framing rules and framing content are typically stored in a local database 403. Framing rules are defined based on sender and/or recipient mail identifier information. Framing engine module 405 submits sender and/or recipient identifiers to decision engine module 401. Decision engine module 401 retrieves frame content based on the appropriate framing rule. The “term” identifier as defined herein refers to an electronic mail address, an IP address, a name or part of a name referring to a sender or recipient of an electronic mail message. Framing engine module 405 processes electronic mail messages and adds content based on the frame content returned by decision engine module 401 once consulted. Statistics agent module 407 retrieves site click statistics from remote web redirection servers 413 using preferably, HTTP protocol. Site click statistics are stored in local database 403. Report agent module 409 generates log reports, preferably in HTML, when requested by an updater service module 411. Updater service module 411 is a communications interface handling the interaction between electronic mail framing server 301 and external applications such as a management application running on management console 303 or a web browser.

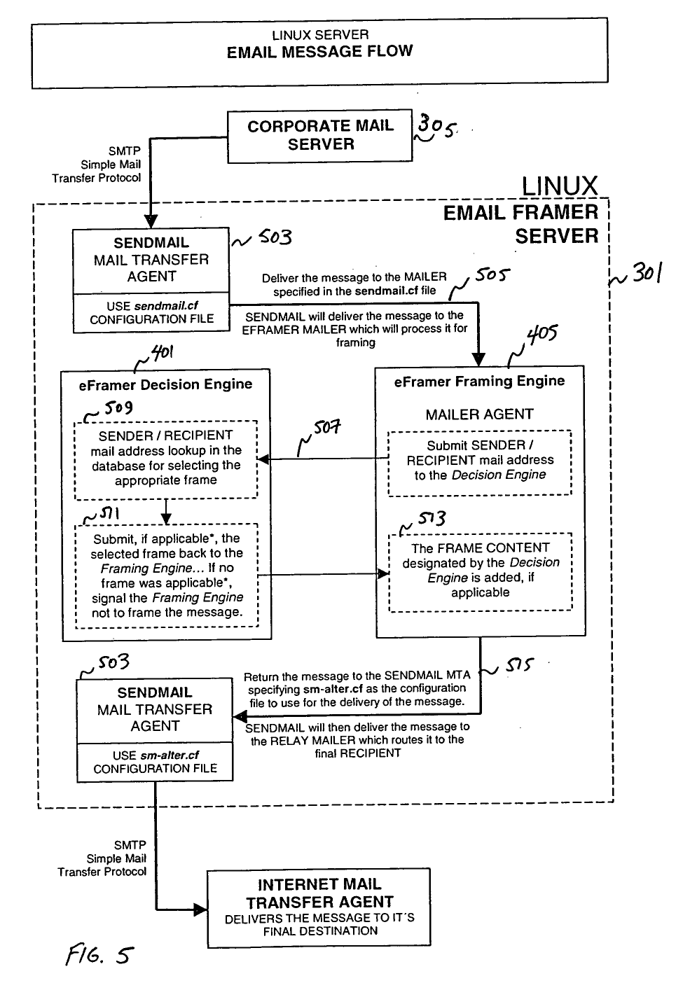

FIG. 5 is an electronic mail message flow diagram, according to an embodiment of the present invention. Corporate mail server 305 requests from a mail transfer agent 503 to process an outgoing mail message. Mail transfer agent delivers the message (step 505) to framing engine module 405 that processes the message for electronic mail framing. Framing engine module 405 submits (step 507) sender and recipient information to decision engine module 401. On receiving sender and recipient information, decision engine module 401 looks up (step 509) in database 403 the sender and recipient information to retrieve the appropriate frame for the outgoing electronic mail message. The selected frame is submitted in response (step 511) back to framing engine module 405. If no frame is applicable, framing engine module 405 is instructed not to frame the outgoing message. On receiving frame content information from decision engine module 401, framing engine module 405 frames the outgoing message (step 513), if applicable. Framing engine module 405 returns (step 515) the message to mail transfer agent 503, specifying an altered configuration file to use for the delivery of the message. Send-mail transfer agent 503 will then deliver the message to mail relay server 307 that routes the message to the final recipient.

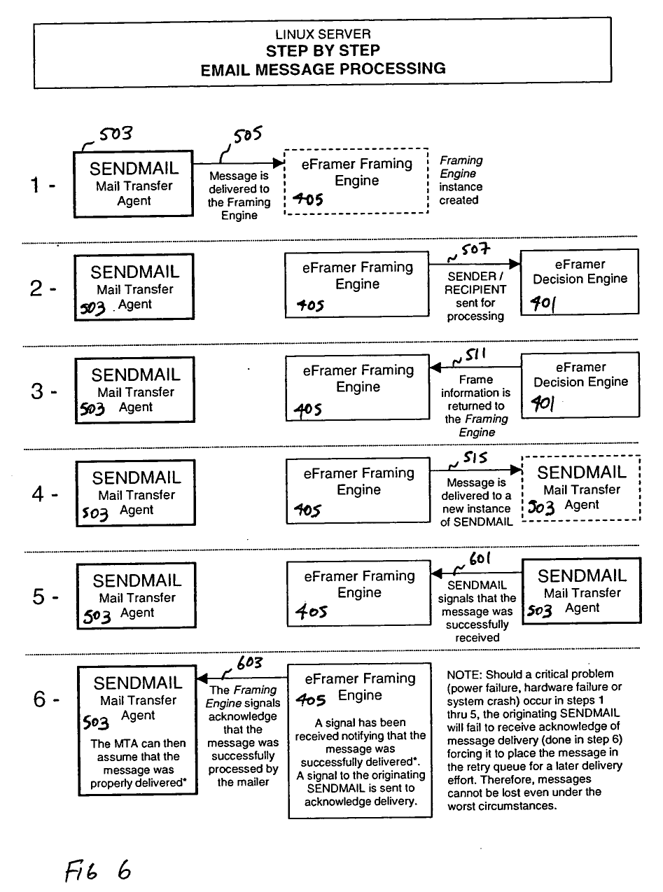

FIG. 6 is a flow diagram showing electronic mail message processing, according to an embodiment of the present invention.

Framing engine module 405 submits (step 507) sender and recipient information to decision engine module 401. The selected frame is submitted in response (step 511) back to framing engine module 405. If no frame is applicable, framing engine module 405 is instructed not to frame the outgoing message. Framing engine module 405 returns (step 515) the message to mail transfer agent 503, specifying an altered configuration file to use for the delivery of the message.

Subsequent to delivering (step 515) a framed message to mail transfer agent 503, mail transfer agent 503 signals (step 601) framing engine module 405 that the message was successfully received. Framing engine module 405 responds to mail transfer agent 503 a signal that the message was successfully delivered and processed (step 603) by the mailer. Should a critical problem (e.g. power failure, hardware failure, system crash) occur the originating mail transfer agent 503 would fail to receive an acknowledgment of message delivery (step 603).

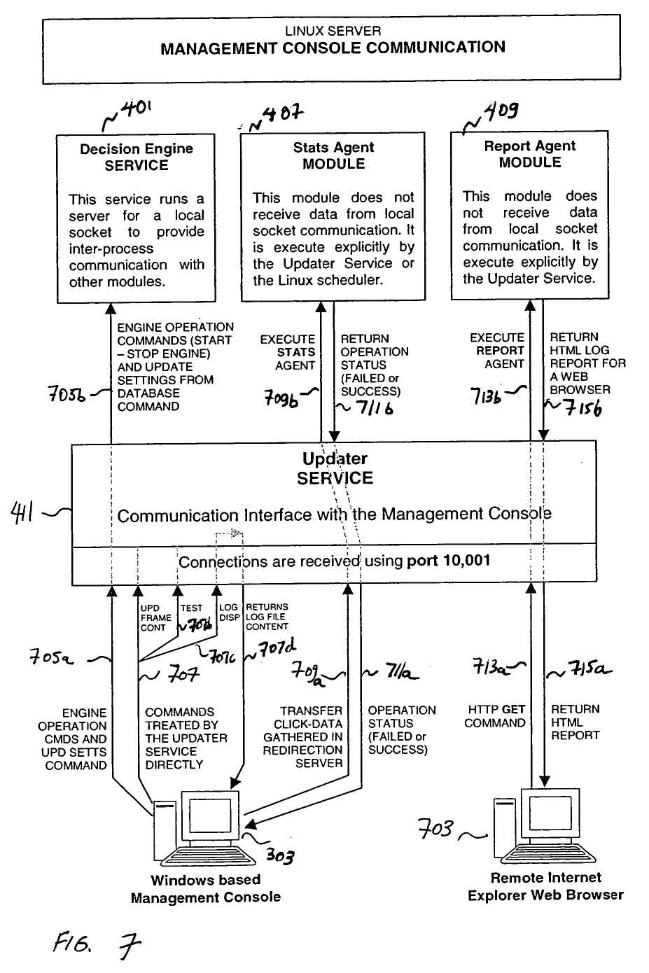

FIG. 7 illustrates management of electronic mail framer server 301 using a management console 303, based on e.g. Microsoft Windows or a remote Internet Web browser 703. Commands and status information of many types are available. Certain commands 705 are delivered to decision engine module 401 directly by the updater service module 411. Commands 705 include start and stop framing, and update settings from database. Other commands 707 are processed directly by updater service module 411 including test requests (step 707b), requests to display a log file (step 707c) and requests (step 707d) for log file content. Other commands initiated from management console 303 to updater service module 411 include transfer click data (step 709a) gathered in re-direction server 413. Updater service module 411 passes transfer click data request 709a to statistics agent module 407. Statistics agent module 407 responds with a return operation status, success or fail, (step 711b) to updater service module 411. The return operation status, success or fail is subsequently passed (step 711a) to management console 303. Similarly, a remote web browser 703 transfers (step 713a) a GET command to updater service module 411. An execute report request (step 713b) is processed by report agent module 409. An HTML log report, is prepared and sent (step 715b) to updater service 411 and subsequently sent (step 715a) to web browser 703.

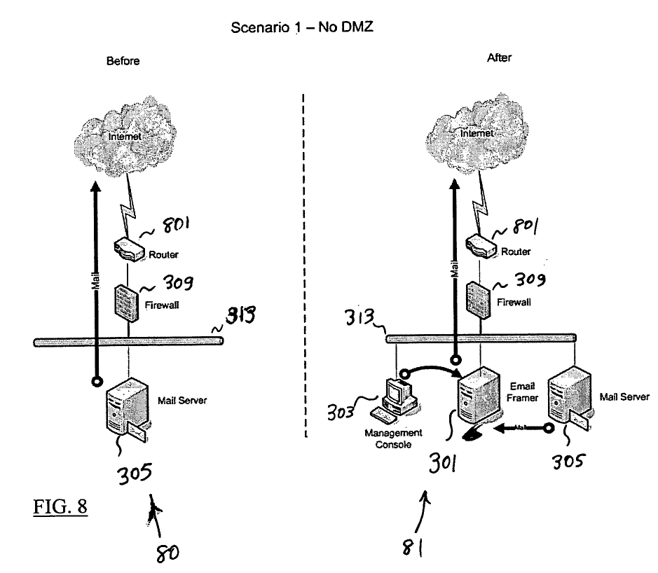

FIG. 8 illustrates system 80 prior to installation of electronic mail framer 301, including corporate network 313, mail server 305 is located in a high security zone protected by firewall 309. Corporate network 313 is connected to the Internet with a router 801. FIG. 8 further illustrates system 81 subsequent to installation of electronic mail framer 301 into a high security zone of system 80, according to an embodiment of the present invention. Electronic mail framer 301 in system 81 is configured to deliver mail using domain name system (DNS). The electronic mail application, e.g Microsoft Exchange, installed on mail server 305 is configured to deliver mail through a second mail server, e.g. Smarthost, to the IP address of electronic mail framer 301.

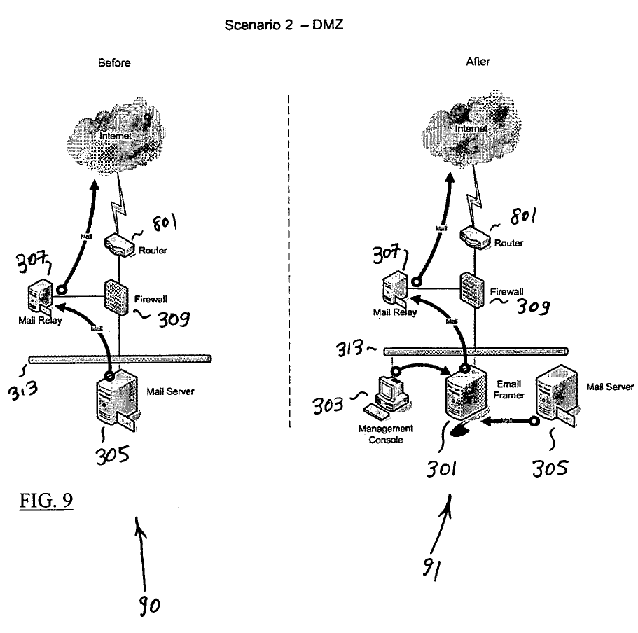

FIG. 9 illustrates system 90 prior to installation of electronic mail framer 301, including corporate network 313, mail server 305 is located in a high security zone protected by firewall 309. System 90 further includes mail relay server 307 located in a “demilitarized zone” and connected to firewall 309. FIG. 9 further illustrates system 91 subsequent to installation of electronic mail framer 301 into a high security zone of system 80, according to an embodiment of the present invention. Mail relay server 307 is configured to accept mail from electronic mail framer 301 as an originator. Electronic mail framer 301 in system 91 is configured to deliver mail using a second mail server, e.g. Smarthost, corresponding to the IP address of mail relay server 307. The electronic mail application, e.g. Microsoft Exchange, installed on mail server 305 is configured to deliver mail through a second mail server, e.g. Smarthost to the IP address of electronic mail framer 301.

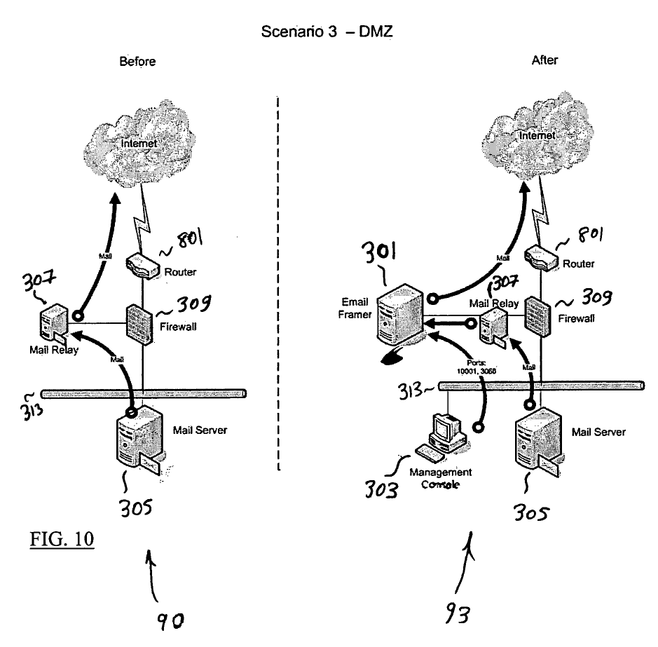

FIG. 10 illustrates system 93, an alternative embodiment of the present invention in which electronic mail framer 301 is installed in the “demilitarized zone” (DMZ) of system 90. Electronic mail framer 301 in system 93 is configured to deliver mail using domain name system (DNS). Specific ports, e.g 3006 and 10001 are opened through corporate network 313 to electronic mail framer 301 in the DMZ. Mail relay server 307 is configured to deliver mail to electronic mail framer 301 Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

While the invention has been described with respect to a limited number of embodiments, it will be appreciated that many variations, modifications and other applications of the invention may be made.

1. A server for modifying electronic mail messages being sent from a computer network, the original electronic mail messages being sent with an electronic mail server by users of the network to recipients, the server comprising:
(a) a database storing a plurality of frames, and a plurality of identifiers of the recipients; and
(b) a processor superimposing at least one of said frames onto at least one of the original electronic mail messages based on at least one identifier thereby producing at least one framed electronic mail message.

2. The server, according to claim 1, wherein said database further stores a plurality of framing rules corresponding to said plurality of identifiers.

3. The server, according to claim 1, wherein said database further stores a plurality of user identifiers and wherein said superimposing is further based on at least one of said user identifiers.

4. The server, according to claim 1, further comprising:
(c) a mail transfer agent receiving the original mail messages from the electronic mail server and sending the original electronic mail messages to said processor.

5. The server, according to claim 1, further comprising:
(c) a mail transfer agent sending said framed electronic mail message to the recipient.

6. The server, according to claim 5, wherein said mail transfer agent is configured to send said framed electronic mail message to a mail relay server.

7. The server, according to claim 1, further comprising:
(c) at least one communications interface with at least one external management application.

8. A method for modifying electronic mail messages being sent from a computer network, the original electronic mail messages being sent with an electronic mail server by users of the network to recipients, the method comprising the steps of:
(a) storing a plurality of frames, and a plurality of identifiers of the recipients; and
(b) superimposing at least one of said frames onto at least one of the original electronic mail messages based on at least one identifier thereby producing at least one framed electronic mail message.

9. The method, according to claim 8, wherein said storing further includes a plurality of framing rules corresponding to said plurality of identifiers.

10. The method, according to claim 8, wherein said storing further includes a plurality of user identifiers and wherein said superimposing is further based on at least one of said user identifiers.

11. The method, according to claim 8, further comprising the step of, prior to said superimposing:
(c) receiving the original mail messages from the electronic mail server.

12. The method, according to claim 8, further comprising the step of:
(c) sending said framed electronic mail message to the recipient.

13. The method, according to claim 12, wherein said sending is via a mail relay server.

14. The method, according to claim 8, further comprising the steps of:
(c) sending commands thereby controlling said storing and controlling said superimposing; and
(d) receiving reports regarding said storing and regarding said superimposing.

15. An electronic mail message modified according to the method of claim 8.

16. An electronic mail message modified according to the method of claim 10.

17. A system for modifying electronic mail messages being sent from a computer network, the original electronic mail messages being sent with an electronic mail server by users of the network to recipients, the system comprising:
(a) an electronic mail framing server including a database storing a plurality of frames, and a plurality of identifiers of the recipients; and further including a processor superimposing at least one of said frames onto at least one of the original electronic mail messages based on at least one identifier thereby producing at least one framed electronic mail message; and
(b) at least one management console for controlling said electronic mail framing server and receiving reports from said electronic mail framing server.

18. The system, according to claim 17, further comprising:
(c) a mail relay server configured to receive electronic mail messages output from said electronic mail framing server.

19. The system, according to claim 17, wherein said database further stores a plurality of user identifiers and wherein said superimposing is further based on one of said identifiers of one of said user identifiers.
